(19) United States
(12) Patent Application Publication
(10) Pub. No.: US 2016/0339523 A1
(43) Pub. Date: Nov. 24, 2016

(54) Cut-Off Tool Holder and Production Method

(71) Applicant: ROSSWAG GMBH, Pfinztal (DE)

(72) Inventors: Gregor Graf, Remchingen (DE); Peter Schlecht, Pfinztal (DE); Sven Donisi, Pfinztal (DE)

(73) Assignee: Rosswag GmbH, Pfinztal (DE)

(21) Appl. No.: 15/113,975

(22) PCT Filed: Dec. 4, 2014
(86) PCT No.: PCT/EP2014/003238

§ 371 Date: Jul. 25, 2016

(30) Foreign Application Priority Data
Jan. 27, 2014 (EP) 14000278.3

(51) Int. Cl. B23B 27/04

(52) U.S. Cl. CPC B23B 27/04

(57) ABSTRACT

The present invention discloses a cut-off tool holder (1) having a plate-like holder body (1′) which has a cutting-tool seat (123). The holder body (1′) has a clamping section (11) for clamping the cut-off tool holder (1) in a machine tool. In the holder body (1′) there is at least one cooling lubricant duct (193), which has at least one outlet opening (18a, 18b) at a side face (122″) of the holder body and leads obliquely out of the side face (122″). The outlet opening (18a) is oriented such that a cooling lubricant jet (K), which emerges from the cooling lubricant duct (193), can be directed onto a face of a cutting tool which is received in the cutting-tool seat (123). Provision is also made of at least one upper cooling lubricant duct (194), which opens into an upper outlet opening (16) that is present on an end face (122′) of the holder body (1′), and of at least one lower cooling lubricant duct (195), which opens into a lower outlet opening (17) that is present on an end face (122′) of the holder body (1′). Furthermore, a production method for producing the cut-off tool holder (1) using a generative manufacturing device is disclosed.

When processing workpieces by cutting, the cutting tool must always be cooled in order to prevent overheating and thus premature wear of the cutting edge. It is known to employ for this purpose cooling lubricants that are supplied to the cutting tool. The cooling lubricants are comprised mainly of water and contain certain additives, for example, for lubrication, modification of the wetting properties, and/or anti-foam agents. Early systems operated with great volume flows and a locally comparatively undefined cooling lubricant application, for example, by means of flexible hoses that were advanced to the cutting tool.

However, this type of cooling action has the disadvantage that the cooling lubricant consumption is very high and the cooling action is not very effective because the location of heat development, i.e., the cutting edge itself, is supplied only insufficiently with cooling lubricant. Thrown-off chips and/or chips that deposit on the cutting tool can deflect in this context the cooling lubricant jet and, in this way, impair cooling of the cutting edge. When cutting narrow grooves or when parting, it may even happen that the cooling lubricant supply to the cutting edge is almost completely shut down.

Therefore, cutting tool holders have been developed that enable supply of the cooling lubricant at high pressure directly to the cutting tool.

Such a cutting tool is disclosed in DE 20 2012 004 900 U1. Here, the cutting tool holder comprises a cooling lubricant duct that enables supply of cooling lubricant directly to the cutting tool seat. The cutting insert or the cutting plate has at its surface a groove-like depression through which the cooling lubricant can be conveyed from an inner duct, formed by a simple bore in the holder body, farther to the cutting edge so that the chips are washed out and therefore flushed away.

Even though heat can be removed directly at the cutting edge, the cooling lubricant supply assist only insufficiently the chip conveyance action because the cooling lubricant stream in the groove of the cutting insert flows only at minimal pressure.

Therefore, cutting tool holders have been developed in which the cooling lubricant exits only shortly before the cutting tool. For example, a parting blade is disclosed in WO 2013 132 480 A1 in which, on a side face, a fluid supply bore is provided that is connected by a capillary bore, which extends along the longitudinal axis of the blade, with an outlet opening directly adjacent to the cutting insert. The fluid supply bore is closed off at one end with a plug in this context while the other end is connected to a cooling lubricant supply of the machine tool. The fluid supply duct is formed here by two fluidically connected bores which are positioned at an angle relative to each other; this leads to flow losses.

Moreover, a parting blade of the manufacturer Sandvik Coromant is known under the term Coroturn® QD (see product catalog “Neue Werkzeuge and Lösungen”, page 21, 2014) and has in the area of the cutting insert two outlet openings for cooling lubricant which are positioned at the end face of the parting blade. One outlet opening is positioned above and the other below the cutting insert. In this context, from a central supply opening a duct is extending to the outlet openings, respectively, wherein the ducts are formed by bores in the blade body.

Based on this prior art, the present invention has the object to provide an improved cut-off tool holder that enables improved local cooling of the cutting tool and an improved chip conveyance.

This object is solved by a cut-off tool holder with the features of independent claim 1.

Moreover, there is the object to provide a production method for the cut-off tool holder with which the latter can be produced inexpensively with few processing steps.

This object is solved by a production method with the features of claim 6.

Preferred embodiments of the device and of the method are described in the dependent claims, respectively.

The cut-off tool holder according to the invention comprises in a first embodiment a plate-shaped holder body that comprises a cutting tool seat. The cut-off tool holder has moreover a clamping section for clamping the cut-off tool holder in a machine tool. In the holding body at least one cooling lubricant duct is provided that, according to the invention, is advantageously provided with at least one outlet opening at a side face of the holder body where the duct is exiting at a slant from the side face. The outlet opening is oriented in this context such that a cooling lubricant jet which is coming from this cooling lubricant duct can be directed onto a surface of a cutting tool that is positioned in the cutting tool seat. The holder body comprises moreover at least one upper cooling lubricant duct which opens at an upper outlet opening that is present at an end face of the holder body and is oriented such that the cooling lubricant jet exiting from the cooling lubricant duct is oriented from above onto a cutting edge of a cutting tool which is received in the cutting tool seat. Moreover, there is/are provided one or several lower cooling lubricant duct/ducts that opens/open each at a lower outlet opening which is present at an end face of the holder body and is oriented such that a cooling lubricant jet exiting from the cooling lubricant duct can be oriented from below onto the cutting edge of the cutting tool which is received in the cutting tool seat.

In this context, “cutting tool” means an exchangeable cutting insert, in particular a reversible cutting plate, that can be comprised, for example, of carbide, diamond, or ceramic. “Slanted” means that the cooling lubricant duct is not exiting perpendicularly to the surface. Cut edge has the same meaning herein as cutting edge, i.e., it means the location where the cutting forces are acting on the workpiece. A plate-shaped holder body is present, for example, in case of a parting blade. However, the holder body can also be only partially plate-shape, for example, only at its end which is oriented toward the workpiece while at the clamping end a standardized geometry for reception in the machine tool is provided, for example, a shaft-shaped holder with polygonal cross-section.

The outlet opening which is present at the side face of the holder body is provided to direct a cooling lubricant jet from the side onto the cutting tool body; this contributes to improving the chip conveyance as well as to keeping cooler the cutting tool body itself which also counteracts the heat expansion of the cut-off tool holder itself.

The cut-off tool holder according to the invention can be in particular a parting blade which in particular is suitable for large parting diameters or a cut-off tool holder for small diameters wherein the holder body, for example, can be connected with an elongate tool shaft in order to couple it with the machine tool. Machine tools in this context means primarily lathes and automatic lathes. The tool holder can also be used in multi-axial machining centers. The cut-off tool holder can be screw-connected to a tool holder of the machine tool wherein through bores for clamping screws may be provided. Alternatively, it can also be clamped in a clamping holder so that the cut-off tool holder according to the invention is received quasi in a superordinate holder wherein the superordinate holder, for example, can be coupled by a form-fit quick release system with the tool receptacle of the machine tool.

The cut-off tool holder according to the invention can also have more than one lateral outlet opening for cooling lubricant. In particular, on side faces of the cut-off tool holder that are facing away from each other outlet bores can be provided which apply from opposite directions cooling lubricant onto the cutting tool. The direction is determined primarily by the orientation of the duct axis. However, it can also be provided that into the outlet bore a nozzle is inserted which is angularly adjustable and enables a change of the outflow direction.

Advantageously, with the cut-off tool holder according to the invention, it is possible to cool the cutting tool body from the side and additionally the cutting zone or cut edge from below and above. Overheating of the entire cutting tool volume can thus be more effectively prevented than before; this increases the service life of the cutting tool and makes manufacture by using the cut-off tool holder according to the invention very cost-effective. Moreover, the cooling lubricant consumption can be reduced because small quantities of cooling lubricant at high pressure can be applied locally in a controlled fashion. The upper and/or lower cooling lubricant duct or ducts can extend as individual ducts within the holder body wherein they can extend in particular in a “star shape” from the supply opening to the respective outlet openings.

In a further embodiment, the holder body can comprise one or several supply opening(s) for cooling lubricant that is/are preferably present in the clamping section wherein the supply opening(s) is/are fluidically connectable with the cooling lubricant source. The cooling lubricant duct extends in this context from the supply opening to the outlet opening.

By means of the supply opening it is possible to couple the cut-off tool holder according to the invention to a cooling lubricant supply system of the machine tool. This can be realized preferably simultaneously with the mechanical coupling action.

In this context, the cooling lubricant duct must not extend along the shortest connection between supply opening and outlet opening but its course can also be adapted with respect to a defined minimum stiffness that is to be achieved. A duct that does not extend straight may however also be necessary when bores or similar elements “block” the direct path. The cooling lubricant duct therefore may also comprise one or several directional change sections that advantageously can be rounded. Due to the rounded configuration of the directional change sections, a reduced pressure loss is achieved which contributes to an energy-saving operation.

It can also be provided however that the upper cooling lubricant duct and/or the lower cooling lubricant duct emerges or emerge from a branch of the first cooling lubricant duct. In this context, first a single duct, for example, is extending away from the supply opening which then branches more and more and in this way can supply a plurality of outlet openings with the cooling lubricant. The branch or branches are provided in this context within the holding body and can advantageously have a fluidically beneficial geometry and have in particular no sudden jumps in diameter or dead water zones.

In an exemplary embodiment, the lateral outlet opening is positioned below the cutting tool seat. In addition, the cut-off tool holder has an end face outlet opening that is positioned above the cutting tool seat and an end face outlet opening below the cutting tool seat. In this context, from the supply opening an upper duct branch extends to the upper end face outlet opening and a lower duct branch that is branching extends to the lateral and to the lower end face outlet opening. The duct axes of the cooling lubricant ducts that extend to the end face outlet openings can be oriented in this context such that an exiting cooling lubricant jet is directed onto the cut edge of the cutting tool. The end face outlet openings ensure an optimal cooling action of the cut zone and chip conveyance while the lateral outlet opening provides cooling lubricant for cooling the cutting tool body.

One or several of the cooling lubricant ducts can have alternatively or additionally a non-circular cross-section, for example, a rectangular cross-section, most preferred a flat rectangular cross-section.

“Flat” means herein a width/height ratio of 1.2 and greater. By means of rectangular duct cross-sections, a comparatively large flow-through surface area can be realized even in case of extremely flat holder bodies while for bores that are always round the surface area that is flowed through correlates directly with the thickness of the holding body. The duct cross-section can also be rounded or in particular oval wherein the major axis can preferably be oriented perpendicular to the holder body. In this orientation, a mechanically very load-resistant duct is provided that can withstand even greater pressure loads acting from the exterior on the holder body and/or the effect of cutting forces.

Finally, a slot whose extension direction is parallel to a receiving plane of the cutting tool can be extending away from the cutting tool seat in the holder body, wherein the slot provides elasticity for clamping the cutting tool in the cutting tool seat.

The slot serves in this context for “weakening” the volume of the holder body which is adjoining the slot in order to be able to elastically deform it more easily. Under the effect of a clamping device, for example, a clamping screw that is screwed in perpendicularly to the slot into the holding body, the slot is narrowed and makes it possible in this way to clamp the cutting tool in the cutting tool seat. The slot can be provided with a rounded portion at the end which is facing away from the cutting tool seat; the rounded portion is formed, for example, by a bore which extends parallel to the slot plane. This reduces also the stress concentration of the slot end.

The production method according to the invention of the cut-off tool holder is carried out by employing a generative processing device. It comprises the following steps:

a) loading a 3D volume data set, describing the holder body of the cut-off tool holder, into the generative processing device;
b) providing a starting material in powder form;
c) stepwise production of a material cohesion of the starting material in powder form, thereby stepwise production of the plate-shaped holder body volume, comprising
the at least one cooling lubricant duct that has at least one outlet opening exiting at a side face of the holder body at a slant from the side face, and
comprising the at least one upper cooling lubricant duct which opens at an upper outlet opening that is present at an end face of the holder body, and comprising
the at least one lower cooling lubricant duct which opens at a lower outlet opening that is present at an end face of the holder body.

By means of generative production methods which are also referred to as additive production methods in order to distinguish them form separating or deforming production methods, even most complex geometries with undercuts, hidden inner parts and the like can be produced that cannot be made by means of casting and/or by cutting processes.

The cut-off tool holder according to the invention is such a component which can be produced only with increased expenditure, or not at all, with conventional manufacturing technology: a cooling lubricant duct that exits at a slant from a side face and extends to a central supply point cannot be produced with conventional drilling technology in the diameter ranges because at least three bores would be required for this purpose. In particular the hydraulic connection of the slanted “bore” forming the lateral outlet openings and of the cooling lubricant duct extending to the supply opening is almost impossible because the parting widths to be manufactured are often less than 2 mm and the holder body therefore is even thinner. Also, the lengths to be drilled often surpass the economically achievable diameter/length ratios in case of elongate holder bodies, for example, parting blades.

By use of generative manufacturing technology, any number of the cooling lubricant ducts with almost any number of outlet openings can be produced without additional costs. In this context, it is even possible to optimally design the inner duct branches in regard to flow mechanics. In particular, dead water zones as they are often produced in the prior art by formation of a duct by several “pieced-together” bores can be avoided. Also, the duct length is no longer limited. For example, any diameter/length ratio can be achieved which would be achievable only by use of extremely expensive deep drilling technology in case of using conventional drilling technology.

It is even conceivable to realize a non-round duct cross-section, for example, square or flat parallelepipedal. In this way, a comparatively large flow-through cross-sectional area can be produced even in extremely thin holder bodies; in contrast, the flow-through cross-section in known solutions is limited directly by the thickness of the holder bodies.

The “3D volume data set” is to be understood herein as a CAD volume model of the holder body that not only describes the envelope surfaces but quasi also the volume as “volume pixels”. It is also possible to initially generate the volume data in the generative processing device wherein the 3D data are provided, for example, as a surface model in STL format and completely enclosed surfaces are interpreted by the generative processing device as volume. In order to obtain a volume body, first the material cohesion of predetermined points in a plane is produced and is then continued plane after plane.

In this way, the component can be produced quasi in one step with minimal post-processing expenditure, or even without any post-processing, and with high precision.

For producing the material cohesion, the starting material in powder form can be melted or the material cohesion is produced by sintering with no melting.

The starting material in powder form can be in particular a metal powder. The generative processing device can be a device for selective laser melting or selective laser sintering. The aforementioned processing devices are however only examples. The production method according to the invention can also be performed by use of other generative processing devices that use, for example, electron beams or other high-energy radiation as energy source.

Finally, when performing the production method, a step for inner smoothing of the at least one first cooling lubricant duct, for example, flow grinding and/or extrude honing, can be performed.

This step is carried out expediently after completion of the component but can also be performed in principle at any other point in time. Flow grinding is to be understood as repeatedly pumping through a grinding solution containing grinding particles wherein in this way the surface roughness is effectively reduced which leads inter alia to a reduced flow resistance or pressure loss during flow passage. This may result in the desired formation of laminar flows in the duct or the ducts. In particular, functional edges such as bifurcations in the “net” of cooling lubricant ducts can be effectively smoothed by means of flow grinding. In addition, adhering powder remaining after the generative production process in the duct structure as well as cross-sectional restrictions can be removed so that a subsequent enlargement of the duct diameter is also enabled. The surface condition of the duct structure which has been smoothed by means of flow grinding comprises additionally grinding traces oriented in flow direction. Upon flow through, they exhibit a reduced frictional resistance; they cannot be produced as such by drilling or friction processes. Of course, all of the cooling lubricant ducts of the cut-off tool holder, or only individual ones, if desired, can be post-treated as described.

These and further advantages will be explained in the following description with reference to the attached Figures. The reference to the Figures in the description serves for assisting the explanations and for facilitating understanding of the subject matter. The figures are only schematic illustrations of the embodiments of the invention.

It is shown in:

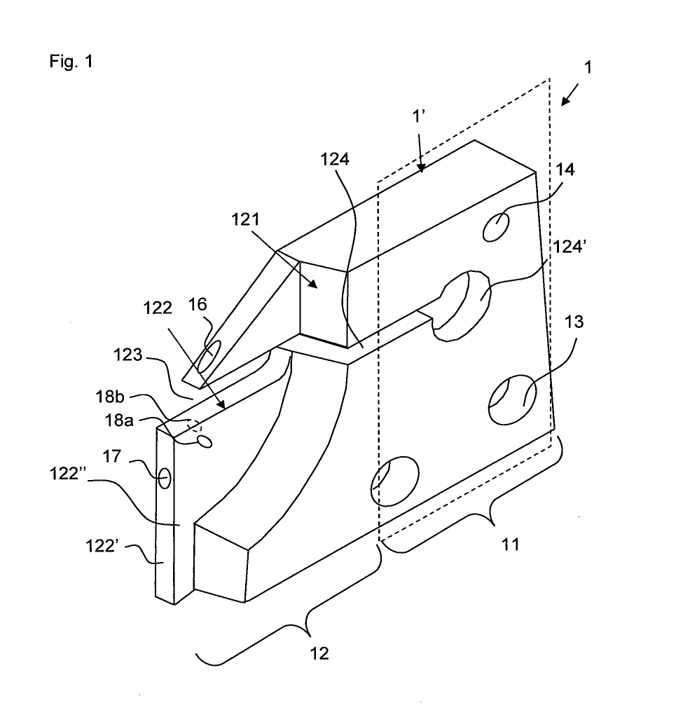

FIG. 1 a perspective partial view of the cut-off tool holder;

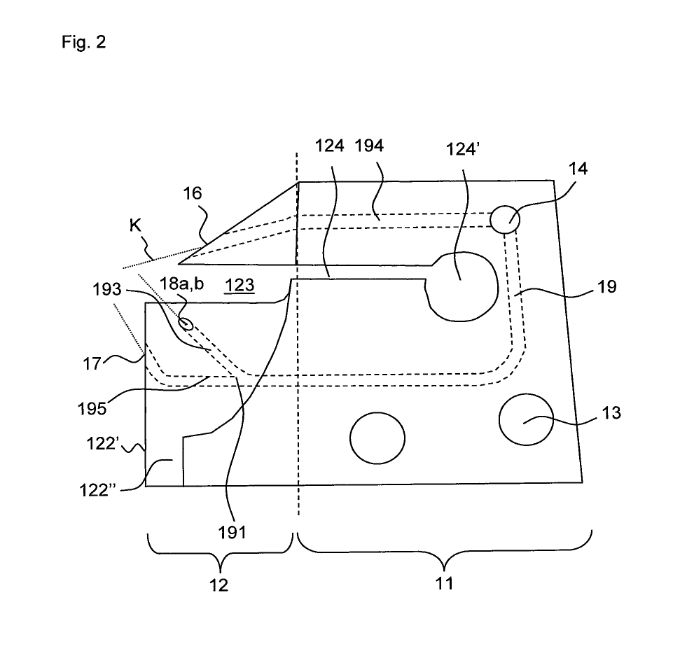

FIG. 2 a plan view of the cut-off tool holder

In FIG. 1, the holder body 1′ is illustrated in longitudinal section wherein the cooling lubricant ducts are not positioned in the section plane but are positioned behind the image plane deeper within the holder body 1′. The holder body 1′ has two sections, the clamping section 11, which is provided for coupling with the machine tool, and the receiving section 12, in which a cutting insert can be received.

The cut-off tool holder 1, or more precisely the holder body 1′, has a cutting tool seat 123 whose shape and dimensions are formed to correspond with a defined cutting tool to be received, for example, a reversible cutting plate. In order to improve the force transmission from the cutting tool into the cut-off tool holder 1, the cutting tool seat 123 can have groove-like depressions extending transversely to the longitudinal direction of the holder body 1′; this is however not illustrated in the Figures. The cutting tool can be clamped in the cutting tool seat 123 in that the slot 124 adjoining the cutting tool seat 123 is elastically deformed by a clamping device which is exerting a clamping force on the holder body perpendicularly to the extension direction of the slot 124. At the “closed end” of the slot 124, a terminal bore 124′ is provided by means of which additional elasticity is provided and which reduces the stress concentration at the slot.

The holder body 1′ has fastening bores 13 which may also be threaded bores; this is not illustrated in the Figures. By means of the fastening bores 13, the holder body 1′ is coupled, enabling force transmission, to a machine tool which can be directly or indirectly achieved. The holder body 1′ can be connected directly with a tool receptacle of a lathe, first clamped in an adapter, or can be part of a cut-off tool holder with elongate shaft. In the clamping section 11, the holder body 1′ has a greater thickness than in the receiving section 12 because the width of a cut-off groove to be produced is to be as small as possible. By means of the rounded portion 121, sufficient movement space for a rotation body is provided while the receiving section 12 is imparted with stiffness.

The holder body 1′ has moreover a central supply opening 14 for cooling lubricant that is coupled with a cooling lubricant system of the machine tool. Cooling lubricant ducts (see in this connection FIG. 2) extend in the holder body 1′ away from the supply opening 14 and open each at an outlet opening 16, 17, 18a, 18b. The cut-off tool holder 1 has four outlet openings 16, 17, 18ab, 18b;

one outlet opening 18a, 18b each is positioned at the side faces 122″ below the cutting tool seat 123 and exits at a slant from the surface wherein one outlet opening 18a, 18b each is provided at wall sections that are facing away from each other; this is illustrated by the dashed illustration of the outlet opening 18b. Two outlet openings 16, 17 are positioned at the end faces 122′ of the holder body 1′, an upper outlet opening 16 that is present above the cutting tool seat 123 and a lower outlet opening 17. Since the cut-off tool holder 1 has several outlet openings 16, 17, 18a, 18b, that also may have different cross -sectional surface areas and flow rates, an optimal chip conveyance and an optimal cooling action are achieved. While the lower end face outlet opening 17 is designed for cooling the cut edge from below, the upper end face outlet opening 16 serves also for chip conveyance and the lateral outlet openings 18a, 18b cool the cutting tool body laterally from below; this contributes to preventing heating of the cutting tool body and preventing transfer of the heat into the holder body 1′. The longitudinal axes of the exiting cooling medium jets K are illustrated in dotted line.

FIG. 2 shows a side view of the partial view illustrated in FIG. 1 wherein the section surface is positioned in the image plane. Hidden edges are illustrated in dashed lines so that the course of the cooling lubricant ducts 19, 193, 194 195 can be explained. The cooling lubricant duct 19 extends from the supply opening 14 as a central supply point in downward direction and curves below the cutting tool seat 123 so as to extend parallel to the slot 124. The cooling lubricant duct 19 branches into the cooling lubricant duct 193, which opens at the lateral outlet openings 18a, 18b at the side faces 122″, and into the cooling lubricant duct 195, which opens at the lower outlet opening 17 at the end face 122′. The branch 191 is of a fluidically beneficial design in order to keep pressure loss minimal. The cooling lubricant duct 194 extends also away from the supply opening 14 and opens at the upper outlet opening 16 at the slanted section of the end face 122′.

With conventional original molding and separating production methods, for example, casting and/or milling/drilling etc., the holder body 1′ with the described duct geometry cannot be produced. Therefore, it is proposed according to the invention to use a generative production method for the production, in particular selective laser melting, so that the holder body 1′ can be produced with minimal mechanical post-processing. The quasi finished holder body can be removed from the device for selective laser melting and is then ready to use after cleaning off residues of starting material in powder form.

What is claimed is:

1.-9. (canceled)

10. A cut-off tool holder comprising:
a plate-shaped holder body comprising a cutting tool seat;
a clamping section configured to clamp the cut-off tool holder in a machine tool;
the holder body comprising at least one first cooling lubricant duct, the at least one first cooling lubricant duct comprising at least one side face outlet opening arranged at a side face of the holder body and exiting at a slant from the side face, wherein the at least one side face outlet opening is oriented such that a cooling lubricant jet exiting from the at least one first cooling lubricant duct is directed laterally onto a surface of a cutting tool that is received in the cutting tool seat;
the holder body comprising at least one second cooling lubricant duct that is opening at an upper outlet opening, wherein the upper outlet opening is located at an upper end face of the holder body arranged above the cutting tool seat and is oriented such that a cooling lubricant jet exiting from the at least one second cooling lubricant duct is directed from above onto a cut edge of a cutting tool that is received in the cutting tool seat;
the holder body comprising at least one third cooling lubricant duct that is opening at a lower outlet opening, wherein the lower outlet opening is located at a lower end face of the holder body arranged below the cutting tool seat and is oriented such that a cooling lubricant jet exiting from the at least one third cooling lubricant duct is directed from below onto the cut edge of the cutting tool that is received in the cutting tool seat.

11. The cut-off tool holder according to claim 10, wherein the holder body comprises at least one supply opening for a cooling lubricant and the at least one supply opening is fluidically connectable with a cooling lubricant source, wherein the first cooling lubricant duct extends from the at least one supply opening to the at least one side face outlet opening.

12. The cut-off tool holder according to claim 11, wherein the at least one supply opening is located in the clamping section.

13. The cut-off tool holder according to claim 10, wherein the at least one first cooling lubricant duct comprises at least one directional change section.

14. The cut-off tool holder according to claim 13, wherein the at least one directional change section is rounded.

15. The cut-off tool holder according to claim 10, wherein the at least one second cooling lubricant duct or the at least one third cooling lubricant duct branches off a common cooling lubricant duct section.

16. The cut-off tool holder according to claim 10, wherein the at least one second cooling lubricant duct and the at least one third cooling lubricant duct branch off a common cooling lubricant duct section.

17. The cut-off tool holder according to claim 10, wherein the at least one second cooling lubricant duct or the at least one third cooling lubricant duct branches off the at least one first cooling lubricant duct.

18. The cut-off tool holder according to claim 10, wherein the at least one second cooling lubricant duct and the at least one third cooling lubricant duct branch off a the at least one first cooling lubricant duct.

19. The cut-off tool holder according to claim 10, wherein one or more of the at least one first cooling lubricant duct, the at least one second cooling lubricant duct, and the at least one third cooling lubricant duct comprise a non-circular cross-section.

20. The cut-off tool holder according to claim 19, wherein the non-circular cross-section is an oval cross-section or a rectangular cross-section.

21. The cut-off tool holder according to claim 10, wherein the holder body comprises a slot having a slot extension direction parallel to a receiving plane of the cutting tool in the cutting tool seat, wherein the slot extends in the holder body in a direction away from the cutting tool seat.

22. A production method for a cut-off tool holder according to claim 10, the production method comprising:
a) loading a 3D volume data set that describes the holder body of the cut-off holder into a generative processing device:
b) providing a starting material in powder form;
c) stepwise generating a material cohesion of the starting material in powder form and thereby stepwise producing the plate-shaped holder body that comprises:
at least one first cooling lubricant duct comprising at least one side face outlet opening arranged at a side face of the holder body and exiting at a slant from the at least one side face;
at least one second cooling lubricant duct opening at an upper outlet opening, wherein the upper outlet opening is located at an upper end face of the holder body located above the cutting tool seat;
at least one third cooling lubricant duct opening at a lower outlet opening, wherein the lower outlet opening is located at a lower end face of the holder body located below the cutting tool seat.

23. The method according to claim 22, wherein the step c) includes melting of the starting material in powder form.

24. The method according to claim 22, wherein the starting material in powder form is a metal powder.

25. The method according to claim 22, wherein the generative processing device is a device for selective laser melting or selective laser sintering.

26. The method according to claim 22, further comprising the step of d) inner smoothing of at least one of the first, second, and third cooling lubricant ducts.

27. The method according to claim 26, wherein the step d) includes a flow grinding step.

28. The method according to claim 27, wherein the step d) includes further an extrude honing step.

29. The method according to claim 26, wherein the step d) includes an extrude honing step.
